(19) United States
(12) Patent Application Publication
(10) Pub. No.: US 2008/0213441 A1
(43) Pub. Date: Sep. 4, 2008

(54) Reduction of Astringency in Polyphenol Compositions

(76) Inventors: Cathy Jean Ludwig, Grayslake, IL (US); Nicole Lee Windsor, Chicago, IL (US); Anikumar Ganapati Gaonkar, Buffalo Grove, IL (US); Nam-Cheol Kim, Deerfield, IL (US); Nathan V. Matusheski, Gurnee, IL (US); Leslie George West, Glencoe, IL (US); Maria Carolina de Almeida Fontes, Munich (DE); Bary Lyn Zeller, Glenview, IL (US); Dominic J. Vellucci, Eastchester, NY (US); Mark Kijowski, Shanghai (CN); Gabriele Margarete Kopp, Munich (DE)

Correspondence Address: FITCH EVEN TABIN & FLANNERY, 120 S. LASALLE STREET, SUITE 1600, CHICAGO, IL, 60603-3406, US

(21) Appl. No.: 11/958,556

(22) Filed: Dec. 18, 2007

Related U.S. Application Data
(60) Provisional application No. 61/007,911, filed on Dec. 27, 2006.

(51) Int. Cl. A23D 7/005; A23P 1/04; A23J 1/20; A23L 1/0562

(52) U.S. Cl. 426/310; 426/655; 426/576; 426/580

(57) ABSTRACT

Microencapsulated polyphenol compositions suitable for use in food and beverage products are provided. Microencapsulation significantly reduces the astringency and/or bitterness of the polyphenol compositions and protects the polyphenol compositions from oxidation, ingredient interactions, enzymatic degradation, and the like while maintaining gastrointestinal bioavailability within the digestive system.

### RELATED APPLICATIONS

This application is based on, and claims benefit, of United States Provisional Application Ser. No. ______ which was converted to a provisional application on ______, 2007 from U.S. patent application Ser. No. 11/616,572, filed on Dec. 27, 2006, all of which are hereby incorporated by reference herein.

### FIELD OF THE INVENTION

The present invention relates to microencapsulated polyphenol compositions suitable for use in food and beverage products and methods for producing such microencapsulated polyphenol compositions. Microencapsulation significantly reduces the astringency and/or bitterness of the polyphenol compositions and protects the polyphenol compositions from oxidation, ingredient interactions, enzymatic degradation, and/or the like while maintaining gastrointestinal bioavailability within the digestive system.

### BACKGROUND OF THE INVENTION

Naturally-occurring polyphenols derived from plants or plant materials (e.g, tea, cocoa beans, and the like) are known to have antioxidant properties as well as providing other potential health benefits. Thus, considerable research has been carried out in recent years with regard to methods for obtaining such polyphenols as well as methods for using them.

Generally, however, such polyphenol compositions are very astringent and/or bitter. Thus, it is difficult to incorporate them into foods or beverages in biologically significant amounts without adversely affecting the taste and/or organoleptic profile of such polyphenol-enriched foods or beverages.

Encapsulation has been used to provide delayed release and/or protection of sensitive materials. For example, U.S. Pat. No. 6,190,591 (Feb. 20, 2001) provides a continuous, and relatively complicated, method for producing controlled release, discrete, solid particles (i.e., matrix) containing an encapsulated and/or embedded component such as a heat sensitive or readily oxidizable pharmaceutically, biologically, or nutritionally active component. A release-rate component is introduced into the matrix to control the release of the active component. U.S. Pat. No. 6,835,397 (Dec. 28, 2004) provides an encapsulated yeast composite comprising a core containing the yeast and a coating containing an emulsified lipid.

Japanese Patent Publication No. 2005-124540A (published May 19, 2005) provides a method for masking or reducing the astringency and bitterness of polyphenol compositions in which casein, especially acid casein, is included in the polyphenol composition. In this method, the polyphenol composition is mixed with a solution or suspension of casein in water, preferably adjusted to a neutral pH. Such a casein-containing polyphenol composition can be used directly in beverages or dried to form a powder for use in foods or beverages. Generally, to obtain sufficient “masking” of the polyphenols, about 40 to about 350 parts (and preferably about 60 to 150 parts) casein was combined with about 100 parts of the polyphenol composition in water. This method does not appear as successful as desired since astringency can still be detected in the mouth (see Example 4 below).

It is desired to provide other and improved methods for reducing the astringency and bitterness of polyphenol compositions. The present invention provides such improved methods for reducing the astringency and bitterness of polyphenol compositions. The present invention also provides polyphenol compositions having significantly reduced astringency and bitterness levels. The present polyphenol compositions can be added at significant levels to food and/or beverage products without adversely affecting the flavor and/or organoleptic properties of the food or beverage products.

### SUMMARY OF THE INVENTION

The present invention relates to microencapsulation of polyphenol compositions in order to significantly reduce astringency and bitterness levels associated with the polyphenol components. The present polyphenol compositions can be added at significant levels to food and/or beverage products without adversely affecting the flavor and/or organoleptic properties of the food or beverage products. Thus, this invention provides polyphenol compositions which retain the original biological activities of polyphenols but without the specific bitterness and astringency normally associated with polyphenols.

### DETAILED DESCRIPTION

The present invention relates to encapsulation or microencapsulation of polyphenol compositions in order to significantly reduce astringency and bitterness levels normally associated with the polyphenol components. The present polyphenol compositions can be added at significant levels to food and/or beverage products without adversely affecting the flavor and/or organoleptic properties of the food or beverage products.

The present invention provides polyphenol compositions which are essentially protected as they pass through the mouth but then allows release of the polyphenol compound contained therein released in the remainder of the digestive system (i.e., stomach, small intestines especially). By preventing or reducing the amounts of the polyphenol compounds from contacting the taste buds in the oral cavity, the present invention significantly reduces astringency and bitterness levels normally associated with polyphenols. The polyphenol compounds are, however, more fully released within the digestive system where they can provide their health benefits. Microencapsulation of polyphenol compositions significantly reduces the astringency and/or bitterness of the polyphenol compositions and protects the polyphenol compositions from oxidation, ingredient interactions, enzymatic degradation, and the like while maintaining gastrointestinal bioavailability within the digestive system.

The encapsulated polyphenol compositions of the present invention can be prepared using conventional encapsulation procedures and edible encapsulating or coating materials so long as the encapsulation allows the polyphenol materials, especially when incorporated into food products, to pass through the oral cavity without significant release of the polyphenols, allows release of the polyphenols as the materials pass through the digestive system after the oral cavity, and maintains bioavailability when released. For purposes of this invention, “without significant release” is intended to mean that the release of polyphenols within the oral cavity is such that the astringency and/or bitterness normally associated with the polyphenols is effectively eliminated or reduced to levels which are acceptable for the particular product in which the polyphenols are incorporated.

Although synthetic polyphenols can be used, the polyphenols used in the present invention are preferably naturally-occurring polyphenols derived from plants or plant materials (e.g, berries, tea, cocoa beans, coffee, vegetables, fruits, and the like as well as combinations thereof) which are known to have antioxidant properties as well as providing other potential health benefits. Such polyphenol compounds normally include catechin, epicatechin, gallocatechin, catechin gallate, epicatechin gallate, gallocatechin gallate, epigallocatechin gallate, epigallocatechin, tannic acid, gallotannin, ellagitannin, caffeic acid, dihydrocaffeic acid, chlorogenic acid, isochlorogenic acid, genitisic acid, homogenitisic acid, gallic acid, ellagic acid, rosemary acid, rutin, quercetin, quercetagin, quercetagetin, gossypetin, anthocyanin, leucoanthocyanin, proanthocyanidin, enocyanin, and the like as well as their derivatives, polymers, and stereoisomers. The polyphenols can be extracted from these plants using conventional techniques (e.g., extraction using one or more solvents selected from water, ethyl acetate, methanol, ethanol, isopropanol, and the like or mixtures thereof).

Generally the encapsulated polyphenols used in the present invention are in powdered form. Although the physical properties can vary depending on the method of encapsulation used and the product in which the polyphenols are to be included, the encapsulated polyphenols, in most embodiments, are preferably roughly spherical and have mean particle size of about 50 to about 1700 microns, preferably about 50 to about 500 microns, and more preferably about 70 to about 120 microns. The reduction in particles size, if necessary, can be made before or after the encapsulated polyphenols are incorporated into the food product. Of course, so long as the desired reduction in astringency and bitterness are obtained while maintaining the desired organoleptic properties of the food product, encapsulated polyphenols having other shapes and/or particle sizes can be used.

For some products (e.g., those having a very smooth texture such as chocolate) the particle size may preferably be in the lower portions of, or even less than, the ranges listed above. Thus, for example, encapsulated polyphenols used in the manufacture of chocolate preferably have, in the final product, a d90 of about 15 to about 100 microns (i.e., 90 percent of particles have a particle size equal to or less than the specific d90 value) and even more preferably of about 20 to about 30 microns in the final product; such a particle size may be achieved by reducing the particle size of the encapsulated polyphenols either before they are added to the product or by reducing the particle size (e.g., milling) the encapsulated polyphenols during or after the manufacturing process of the product in which the encapsulated polyphenols are to be included.

The encapsulating material or coating material must be edible and provide controlled release within the human body when consumed. For purposes of this invention, “controlled release” is intended to mean non-release or significantly reduced release during normal mastication conditions but then increased release (essentially complete release) while passage through the remainder of the digestive system (i.e., stomach and/or small intestines) where bio-absorption can occur. By avoiding or significantly reducing release in the mouth during normal ingestion of food containing such polyphenol compositions, the astringency and bitterness normally associated with polyphenols is avoided, thereby allowing the incorporation of the encapsulated polyphenol compositions in a wider range of food products and/or incorporation at higher levels without adversely affecting organoleptic properties of the food product in which they are incorporated. For purposes of this invention, “normal mastication processes” are intended to include normal chewing activities in the mouth during consumption of food up to the time the masticated food is swallowed. For purposes of this invention, “normal digestive processes” are intended to include normal digestive process occurring after the masticated food is swallowed; generally, such processes will include mixing and digestion of the food in the stomach as well as passage of the mixed and digested food through the small intestines.

The encapsulating or coating composition should remain intact (thereby preventing and/or substantially reducing release of the polyphenols) for at least about 30 seconds, and preferably at least about 60 seconds, in the oral cavity (essentially for a time sufficient to allow chewing and swallowing of the food product containing the encapsulated polyphenols) but then be broken down, to allow release of the polyphenols in the stomach and/or small intestines. For purposes of this invention, the actual mechanism by which the encapsulated polyphenols remain essentially unreleased or by which release is delayed in the oral cavity but then provides for release in the remainder of the digestive systems is not critical.

Examples of suitable encapsulating or coating materials for use in the present invention include lipids, gelatin, shellac, gum arabic, waxes, polymers, mixtures of proteins and carbohydrates, and the like as well as combinations thereof. The amount of encapsulating or coating material relative to the polyphenols is generally an effective amount to reduce astringency and/or bitterness normally associated with polyphenols while maintaining the organoleptic properties in acceptable ranges. Generally, the prepared encapsulated polyphenols contains about 60 to about 95 percent polyphenols and about 5 to about 40 percent encapsulating material, and preferably about 70 to about 90 percent polyphenols and about 10 to about 30 percent encapsulating material.

Especially preferred lipid coating compounds for use in fluidized bed encapsulation systems include hydrogenated palm oil, acetylated monoglycerides, hydrogenated cottonseed oil, hydrogenated soybean oil, hydrogenated coconut oil, cocoa butter, and the like. Preferably the gelatin coating composition contains about 2 to about 20 percent gelatin, about 1 to about 5 percent glycerol, and about 75 to about 97 percent water. Type A or B gelatin can be used.

Especially preferred mixtures of proteins and carbohydrates for use in spray drying encapsulation systems include proteins such as milk proteins (e.g., milk protein isolate, sodium caseinate, total milk protein, whey protein, and the like) and soy proteins (e.g., soy protein isolate and the like) and carbohydrates such as maltodextrin, trehalose, corn syrup solids, and the like. More preferably, the protein is a milk protein with milk protein isolate and sodium caseinate being most preferred and the carbohydrate is maltodextrin or trehalose with maltodextrin being most preferred. Generally the carrier system used in spray drying is aqueous based and contains about 30 to about 70 percent protein and about 30 to about 70 percent carbohydrates, and more preferably about 35 to about 45 percent protein and about 55 to about 65 percent carbohydrates. Generally, the spray dried prepared encapsulated polyphenols contains about 20 to about 60 percent polyphenols and about 40 to about 80 percent encapsulating material, and preferably about 30 to about 50 percent polyphenols and about 50 to about 70 percent encapsulating material. Although not wishing to be limited by theory, it appears that in the spray drying system, the encapsulation may be achieved by physically absorbing and/or adsorbing the polyphenols along the individual protein chains. In addition to this physically absorption and/or adsorption, the polyphenols can also be essentially contained within a matrix formed by the carrier materials. Regardless of the mechanism or mechanisms involved, the spray dried compositions provide an effective system for reducing the effects of the polyphenols (e.g., reduced astringency and/or bitterness).

The thickness and nature of the coating composition around the polyphenol particles should be effective to prevent and/or delay release in the oral cavity and then to provide release in the remainder of the digestive system and thus reduce astringency and bitterness in the oral cavity. Generally, the coating composition forms an encapsulating layer, coating, or matrix protecting the polyphenol particles of about 1 to about 100 microns (about 0.001 to about 0.1 mm) thick, and preferably about 10 to about 40 microns (about 0.01 to about 0.04 mm) thick. The encapsulating layer, coating, or matrix protecting the polyphenol particles may have a uniform or non-uniform thickness. Generally, the encapsulated polyphenol compositions contains about 60 to about 95 percent polyphenols and about 5 to about 40 percent encapsulating material, preferably about 70 to about 90 percent polyphenols and about 10 to about 30 percent encapsulating material. Of course, the relative amounts of the polyphenols and encapsulating material and the thickness of the encapsulating layer, coating, or matrix may vary so long as the astringency and bitterness of the polyphenols are effectively reduced in the oral cavity. In some cases (e.g., the matrix formed with the spray drying encapsulating technique), it may be preferred to further grind the encapsulated polyphenol compositions in order to obtain the desired particle size distribution. Such further grinding may be carried out on the encapsulated polyphenols before or after introduction into the desired food product. Generally, the particle size is preferably adjusted to reduce or avoid the perception of grittiness while maintaining the desired reduction in astringency and bitterness levels in the final polyphenol-containing food product.

Of course, the appropriate particle size can be determined on a case-by-case basis and will likely depend on the type of food product desired. For example, for a food product normally having a crunchy texture, a higher particle size can be used whereas a smooth texture product will likely require a smaller particle size. For products having a very smooth texture (e.g., high quality chocolate), the particle size will generally be preferred to be lower. Thus, for example, the encapsulated polyphenols used in the manufacture of chocolate preferably has a d90 of about 15 to about 100 microns (i.e., 90 percent of particles have particles equal to or less than a specific value) and even more preferably of about 20 to about 30 microns in the final product; such a particle size may be achieved by reducing the particle size of the encapsulated polyphenols either before they are added to the product or by milling the polyphenol-enriched product during or after the manufacturing process.

Encapsulation can be carried out using any conventional technique. Examples of such techniques include fluidized bed encapsulation, extrusion, spray drying, prilling, spinning disk, and the like. Preferably fluidized bed or spray drying systems are used for encapsulation.

The encapsulated polyphenol compositions of this invention are especially designed to allow incorporation of significant level of polyphenols in food products for human or animal consumption without the astringency and bitterness levels normally associated with polyphenols. Generally, the encapsulated polyphenol of this invention are incorporated into the desired food product at a level of about 1 to about 20 percent, preferably at about 1 to about 10 percent, using any suitable technique. Thus, for example, encapsulated polyphenol compositions—especially those prepared by spray drying polyphenols using mixtures of proteins and carbohydrates—may be incorporated into dark or milk chocolate to significantly increase the amount of polyphenols without adversely affecting the organoleptic properties of the chocolate. For polyphenol-containing chocolate, it has been found that spray dried polyphenol encapsulated material can be added at many stages of the chocolate manufacturing process. Such spray dried polyphenol encapsulated material is preferably incorporated into the chocolate at or near the end of the conching treatment in conventional methods for making chocolate. The conched material containing the polyphenol encapsulated material is preferably then ball milled and further treated using conventional chocolate making technology. The ball milling step appears to reduce the particle size of the polyphenol encapsulated material to levels effective to reduce or avoid the perception of grittiness while maintaining the desired reduced astringency and bitterness levels. Of course, other methods to obtain the desired particle size of the encapsulated polyphenols in the final product can be used. For example, the spray dried polyphenol encapsulated material could be ground to a desired particle size before being added to the chocolate. Dark chocolate containing levels of about 500 mg or more polyphenols per 60 g chocolate and milk chocolate containing levels of about 200 mg or more polyphenols per 60 g chocolate can be prepared having good organoleptic properties. These levels represent a significant increase in polyphenol content as compared to traditional chocolate as well as polyphenol-enriched chocolate currently available (i.e., about 200 mg polyphenol per 60 g dark chocolate or about 100 mg polyphenol per 60 g milk chocolate). The polyphenol-enriched chocolate currently available generally have been obtained by either (1) selecting starting materials with relative high levels of polyphenols and/or adjusting manufacturing conditions to help maintain the polyphenol levels in the starting materials or (2) adding increased levels of polyphenols. Using the first technique, significantly high levels of polyphenols (i.e., as high as obtained in the present invention) can generally not be obtained without significantly astringency and bitterness; and using the second technique, although high levels of polyphenols can be obtained, the astringency and bitterness associated with polyphenols becomes very apparent. The present invention, however, allows significantly higher polyphenol levels to be obtained without the astringency and bitterness normally associated with polyphenols.

The invention will now be illustrated by specific examples which describe preferred embodiments of the present invention. They are not intended to limit the scope of the invention. Unless otherwise indicated, all ratios and percentages throughout this specification are by weight. All patents and other publications discussed in this specification are hereby incorporated by reference.

Examples 1-4 illustrate encapsulated polyphenol compositions prepared in a fluidized bed system. Examples 5-8 illustrate encapsulated polyphenol compositions prepared in a spray drying system; the resulting spray dried polyphenol composition is then incorporated into chocolate.

### EXAMPLE 1

This Example illustrates the microencapsulation of a polyphenol composition with a lipid (a hydrogenated palm fat from Humko Oil Products, Cordova, Tenn.). VitaBerry™ (Van Drunen Farms, Momence, Ill.) was used as the polyphenol composition; it was stored in a freeze prior to use. VitaBerry™ is a powdered blend of concentrated fruit extracts and whole-fruit powders which contains natural antioxidants having high oxygen radical absorbent capacity (ORAC) values and phytochemicals; the polyphenol content is about 30 percent. The polyphenol composition was sieved to a size of 0.089 to 0.122 mm (about 140-100 mesh).

The coating of the polyphenol composition was carried out using a hot-melt fluidized bed system (Uni-Glatt GmbH, Ramsey, N.J.). The fluidized bed system was started up about one hour in advance to allow the system to obtain operating temperature. The hydrogenated palm fat (99 g; melting point about 57° C.) was melted using a hot plate. Thirty minutes before the coating was applied, the polyphenol composition was removed from the freezer and allowed to warm to room temperature. The polyphenol composition (200 g) was then added to the fluidized bed system and fluidization bed was started. After about 1 to 2 minutes (to allow the polyphenol composition to reach the operating temperature of about 70° C.), the flow of the melted lipid was begun and then maintained at a rate of about 4 to about 5 ml/min. Throughout the run the fluidized bed chamber was tapped with a rubber mallet and the shaker function was used approximately every two to three minutes to maintain a uniformly fluidized bed. After all of the hydrogenated palm fat had been fed, the fluidized bed was stopped and the encapsulated polyphenol composition was removed. The encapsulated polyphenol composition was spread on parchment paper and allowed to cool for about 30 minutes. The ratio of the polyphenol composition to lipid was about 70:30. The encapsulated polyphenol composition was sieved to a size of 0.250 to 1.7 mm and stored in a glass jar covered with aluminum foil in a freezer. Evaluation of the lipid-coated polyphenol composition is provided in Example 4.

### EXAMPLE 2

This Example illustrates the microencapsulation of a polyphenol composition (i.e., the VitaBerry™ used in Example 1) with a gelatin (100 bloom Type A; Great Lakes Gelatin, Grayslake, Ill.) using essentially the same equipment and procedure (except as noted) as in Example 1. The gelatin coating composition was prepared by heating water (about 150 g) to about 100° C.). Gelatin (about 10 g) was then slowly added with stirring. Once all the gelatin was dissolved, glycerol (about 2 g; (Dow Chemical, Pevely, Mo.) was added and stirring continued for about 5 minutes to obtain an uniform mixture. The coating solution is kept at about 70° C. and covered until used. The hot-melt fluidized bed system was modified so that the inlet line for the coating composition could be heated so as to maintain the coating composition at a temperature of about 85° C. as it entered the fluidized bed chamber.

After allowing the polyphenol composition (about 50 g) to obtain the operating temperature in the fluidized bed chamber, the flow of the coating composition (about 170 g) was begun and maintained at about 4 to 5 ml/min. Throughout the run the chamber was tapped with a rubber mallet and the filter blow back function used about every five to ten minutes to keep the filters clean and reduce excessive powder loss. After all of the gelatin solution had been applied to the polyphenol composition, the encapsulated polyphenol composition was removed as a dry powder. After cooling, was sieved to a size of 0.250 to 1.7 mm and stored in a glass jar covered with aluminum foil in a freezer. The ratio of the polyphenol composition to gelatin coating was about 70:30. Evaluation of the gelatin-coated polyphenol composition is provided in Example 4.

### COMPARATIVE EXAMPLE 3

This Example illustrates, for comparative purposes, polyphenol compositions prepared by methods described in Japanese Patent Publication No. 2005-124540A. The same starting polyphenol composition as used in Examples 1 and 2 was used. Evaluations of the three comparative samples described herein are also provided in Example 4.

Sample 1. Acid casein (7.5 g; Dairygold Co-Operative Society Limited, Ireland) was mixed with 7.5 ml of 0.1 N sodium hydroxide in 80 ml deionized water for one hour at room temperature. The polyphenol composition (12 g) was then added and mixing continued for an additional hour at room temperature. The solution was then poured into a small bread pan and covered with aluminum foil and stored in a freezer overnight. The frozen solution was then placed in a freeze dryer (Virtis Genesis 25XL) and freeze dried for approximately 3.5 days. After freeze drying, a casein-containing polyphenol composition in the form of a powder was obtained and then stored in glass jars in a freezer.

Sample 2. A second comparative sample was prepared exactly as in Sample 1 above except that the initial casein solution contained 7.5 g acid casein, 7.5 ml 0.1 N sodium hydroxide, and 0.475 g sodium tripolyphosphate in 80 ml deionized water. The same polyphenol composition (12 g) was added and treated as for Sample 1. After freeze drying, a casein-containing polyphenol composition in the form of a powder was obtained and then stored in glass jars in a freezer.

Sample 3. Acid casein (49.4 g; same as used in previous samples) and sodium carbonate (3.3 g) were added to deionized water (1769.3 g) and mixed until dissolved. The same polyphenol composition (79 g) as used in the previous samples was slowly added and the entire solution was mixed. The resulting solution was then spray dried using an APV Anhydro Laboratory Spray Dryer Type PSD 52 at a flow rate of about 10 ml/min, an inlet temperature of about 170° C., outlet temperature of about 72° C. (initial) to about 87° C. (final) to obtain a powdered casein-containing polyphenol mixture, which was stored in a freezer.

### EXAMPLE 4

The compositions prepared in Examples 1-2 and Comparative Example 3 were evaluated.

Dissolution. In order to evaluate treatment methods and their effect on astringency and bitterness levels associated with the polyphenol components, the various samples were tested in various solutions to simulate (1) saliva from the mouth, (2) gastric juices from the stomach, and (3) intestinal fluids from the small intestines. Simulated saliva was obtained from A. S. Pharma (East Sussex, UK). Simulated gastric juices and simulated intestinal fluids were prepared according to United States Pharmacopeia (Edition 29, p. 3171). To simulate gastric and intestinal digestion, 25 mg of sample was weighed into 15 ml polypropylene centrifuge tubes, 10 ml of solution (warmed to 37° C.) was added and the tube capped. The tubes were rotated end-over-end at 25 rpm and 37° C. for 1 hour, then immediately drained through a glass microfiber filter (VWR grade 691) where the undissolved material was retained. A sample of the filtrate was collected and analyzed for total phenolics by the Folin-Ciocalteu assay (see, Singleton et al., Am. J. Enol. Vitic., 16:144-158 (1965)). A similar procedure was used to simulate contact with saliva, except tubes were rotated for only 30 seconds prior to draining.

The powdered polyphenol compositions (generally about 25 mg) were incubated in the various simulated solutions (generally about 10 ml) at 37° C. for 30 seconds for the simulated salvia solution and for 1 hour for the simulated gastric and intestinal fluids. After each incubation, the amount of polyphenols released into the respective solutions from the test samples was determined using the Folin-Ciocalteu assay (see, Singleton et al., Am. J. Enol. Vitic., 16:144-158 (1965)); the percent recovery of polyphenols was then calculated. The following results were obtained.

| | Recovery (%) of Polyphenols | | |
|---|---|---|---|
| | Simulated | Simulated Gastric | Simulated Intestinal |
| | Saliva | Juices | Juices |
| Example 1 | 10.3 | 89.6 | 86.5 |
| (Inventive) | | | |
| Example 2 | 9.4 | 91.0 | 79.9 |
| (Inventive) | | | |
| Comparative | 21.4 | 88.2 | 84.8 |
| Sample 1 | | | |
| Comparative | 47.6 | 88.2 | 88.7 |
| Sample 2 | | | |
| Comparative | 21.9 | 85.9 | 84.8 |
| Sample 3 | | | |

As can be seen from this data, the inventive samples show significantly less release of polyphenols in the stimulated salvia solution than comparative samples. Thus, when the inventive samples are consumed, considerably less polyphenols will be released in the mouth, thereby significantly reducing astringency and bitterness levels. Data from the simulated gastric and intestinal fluids show that the inventive samples will release their polyphenols during the digestive process. Thus, as compared to the comparative samples, the inventive samples will provide their polyphenols during the digestive process (i.e., within the stomach and small intestines) and not within the mouth.

Degradation by Polyphenol Oxidate. The various examples were also evaluated to determine their ability to avoid degradation by polyphenol oxidate. This set of experiments models the degradation of polyphenols in a model food matrix due to the presence of polyphenol oxidate enzyme. To determine the extent of protection against polyphenol oxidate enzyme, Comparative samples (about 7 mg; casein treated) or inventive samples (10 mg; encapsulated) from Comparative Example 3 (Samples 1 and 2 only) and Examples 1-2, respectively, were placed in 15 ml polypropylene centrifuge tubes. In addition, an unencapsulated polyphenol sample (about 7 mg) was treated in the same manner. Test solutions (5 ml) of 80:20 glycerol:water with or without polyphenol oxidate (2 mg/ml; Sigma-Aldrich, St. Louis, Mo.) was added and each tube capped. The tubes were rotated end-over-end for one hour at 22° C. and then sparged with air at 30 minutes. Any enzymatic reactions were then stopped by heating the tubes in boiling water for 10 minutes; the samples were then cooled on ice. The resulting solutions were centrifuged for 20 minutes at 10,000 G. The supernatant was collected and then evaluated for total phenolics using the Folin-Ciocalteu assay as above. The following results were obtained:

| | Recovery (%) of Polyphenols |
|---|---|
| Example 1 (Inventive) | 76.4 |
| Example 2 (Inventive) | 96.3 |
| Comparative Sample 1 | 93.4 |
| Comparative Sample 2 | 75.4 |
| Unencapsulated | 70 |

### EXAMPLE 5

This Example illustrates the general spray drying procedures used to encapsulate polyphenol compositions as well as methods to evaluate the effect of the encapsulated polyphenols in chocolate.

All of the powdered ingredients, including the polyphenols, were mixed in a Hobart mixer (Hobart-50, 5 quart, paddle attachment, max 1725 rpm): dry powders were mixed at low speed. Water was then added slowly to the Hobart mixer at a low speed to avoid lumps, foaming, and/or large increases in viscosity; sieving was performed if necessary. The resulting slurries were generally prepared so as to obtain about 45 percent solids.

The slurries were fed into a Niro Mobile Minor™ spray dryer (L/W/H 1800/925/2200 mm) using a peristaltic pump (Cole Parmer Masterflex L/S Easy-Load). Feeds were atomized into a spray using a vaned wheel rotating at high speed (generally about 27000 rpm). Hot air entered the chamber around the wheel, drying the spray to produce a powder, which is then separated from the air in a cyclone. Compressed air (4-5 bar) was used to power the atomizer and the dryer roof (pneumatically lifted). During operation, the air inlet temperature was around 155-170° C. and the outlet temperature was around 95-105° C. The spray dryer and atomizer were disassembled and washed with water once or twice per day as needed to prevent extensive powder build up as well as significant cross contamination between samples. The spray dried polyphenol powder was collected for evaluation.

The resulting encapsulated polyphenols were then incorporated into a commercial liquid dark chocolate mass taken from an operating commercial production line (i.e., after the conching step). This commercial chocolate mass contained about 300 mg polyphenols per 100 g (averaged over several months of normal production runs). The spray dried polyphenol compositions were then manually added and mixed with the chocolate mass, and then manually tempered and moulded to produce chocolate tablets. The amount of encapsulated polyphenol composition added was adjusted to achieve an overall polyphenol level of at least about 500 mg polyphenol per 60 g (or about 830 mg polyphenol per 100 g). The polyphenol content of the polyphenol extracts used to prepare the spray dried compositions was determined using HPLC; this method measures intact procyanidin molecules (e.g., epicatechin and catechin) as well as dimers, trimers, tetramers, and the like forms. The chocolate tablets were then stored at about 16° C. for about three weeks to allow for fat or cocoa butter crystallization before sensory evaluations were conducted using a trained test panel.

### EXAMPLE 6

This Example provides early experiments using spray drying to encapsulate grapeseed polyphenol extracts obtained from Planteextrakt. Generally the same spray drying and evaluation procedures as described in Example 5 were used. The compositions used for spray drying consisted of a aqueous slurry containing the extract and the tested carriers in a ratio of 30/70. The encapsulated compositions were added at a level of about 5.3 percent to a liquid chocolate sample taken from a commercial production line. The following control samples were also prepared: Control 1—chocolate (no additives); Control 2—grapeseed extract (1.6 percent) mixed into chocolate (no carrier or spray drying); and Controls 3, 5, and 7—mixing powdered grapeseed extract and carrier in the same proportions (no spray drying) into chocolate. Sensory evaluations were carried out on the chocolate samples after about 3 weeks.

The following samples were prepared and evaluated. Except for Control 1, all samples contained about 1.6 percent grapeseed extract; none of the control samples involved encapsulation; Samples 4, 6, 8, and 10 contained encapsulated polyphenols prepared with various carriers (ratio of grapeseed extract to carrier was 30/70).

| | Carrier/ | Polyphenol | |
|---|---|---|---|
| | Treatment* | (mg/100 g) | Evaluation |
| Control 1 | No additives/ | 311 | less astringent than any other sample |
| | No encapsulation | | |
| Control 2 | No carrier/added | 450 | strongly astringent, very sour, very bitter, earthy, |
| | grapeseed extract/ | | burnt notes, cocoa |
| | No encapsulation | | |
| Control 3 | Non-fat Dry Milk/ | 410 | Similar to Control 2 |
| | No encapsulation | | |
| 4 | Non-fat Dry Milk/ | 397 | less burnt, more chocolaty, less astringent, sour, |
| | Encapsulated | | slightly salty aftertaste |
| Control | Maltodextrin/ | 408 | Similar to Control 2 |
| 5 | No Encapsulation | | |
| 6 | Maltodextrin/ | 399 | Astringency between Control 1 and Control 5 |
| | Encapsulated | | |
| Control 7 | Whey Powder/ | 407 | Similar to Control 2 |
| | No Encapsulation | | |
| 8 | Whey Powder/ | 407 | Sour aftertaste, less bitter, slightly chocolaty, less |
| | Encapsulated | | overall taste than Sample 10, similar to Control 2 |
| Control 9 | Trehalose & | 408 | More bitter aftertaste, more astringent than |
| | Sodium Caseinate | | Sample 10 but less than Control 2 |
| | (30/70)/ | | |
| | No Encapsulation | | |
| 10 | Trehalose & | 408 | More chocolaty than Sample 4, less astringent |
| | Sodium Caseinate | | than Control 2, slightly sour, less burnt than |
| | (30/70)/ | | Control 1 and Sample 4 (but more than Control 1), |
| | Encapsulated | | less bitter, best of encapsulated samples; closer |
| | | | to control 1 than to control 2 |

*Except for Control 1, all samples contained grapeseed extract.

### EXAMPLE 7

Using the procedures in Example 5 and guided by the results of Example 6, the following components were used to prepare encapsulated polyphenols. Many of these encapsulated polyphenols were then incorporated into chocolate for evaluation as described in Example 5. The spray dried compositions are presented below.

| | Protein* | Carbohydrate** | Polyphenol^{†} | Other^{‡} |
|---|---|---|---|---|
| | Amount (%) | Amount (%) | Amount (%) | Amount (%) |
| 1 | Alanate 155 | Trehalose | CocoanOX 70 | — |
| | 22.5 | 47.5 | 30 | |
| 2 | Alanate 180 | Trehalose | CocoanOX 70 | — |
| | 22.5 | 47.5 | 30 | |
| 3 | Alanate 180 | Maltodextrin (10DE) | CocoanOX 70 | — |
| | 22.5 | 47.5 | 30 | |
| 4 | Alanate 180 | Maltodextrin (10DE) | CocoanOX 70 | — |
| | 22.5 | 32.5 | 45 | |
| 5 | Alanate 180 | Maltodextrin (10DE) | CocoanOX 45 | — |
| | 22.5 | 47.5 | 30 | |
| 6 | Alanate 180 | Maltodextrin (10DE) | CocoanOX 45 | — |
| | 22.5 | 32.5 | 45 | |
| 7 | Alanate 180 | Maltodextrin (10DE) | CocoanOX 70 | Cocoa Butter |
| | 22.5 | 42.5 | 30 | 5 |
| 8 | Alanate 180 | Maltodextrin (10DE) | CocoanOX 70 | MM-100 |
| | 22.5 | 47.4.5 | 30 | 0.1 |
| 9 | Alanate 180 | Maltodextrin (10DE) | CocoanOX 70 | Cocoa Butter |
| | 22.5 | 37.5 | 45 | 10 |
| 10 | Alanate 167 | Maltodextrin (10DE) | CocoanOX 45 | — |
| | 22.5 | 32.5 | 45 | |
| 11 | TMP 1104 | Maltodextrin (10DE) | CocoanOX 70 | — |
| | 22.5 | 47.5 | 30 | |
| 12 | TMP 1104 | Maltodextrin (10DE) | CocoanOX 45 | — |
| | 22.5 | 32.5 | 45 | |
| 13 | Pro-Fam 873 | Maltodextrin (10DE) | CocoanOX 70 | — |
| | 22.5 | 47.5 | 30 | |
| 14 | Pro-Fam 873 | Maltodextrin (10DE) | CocoanOX 45 | — |
| | 22.5 | 32.5 | 45 | |
| 15 | Alanate 385 | Maltodextrin (10DE) | CocoanOX 45 | — |
| | 22.5 | 32.5 | 45 | |

*Alanate 155 is sodium caseinate; Alanate 180 is sodium caseinate; Alanate 167 is partially hydrolyzed sodium caseinate; Alanate 385 is calcium caseinate; TMP 1104 is total milk protein (i.e., milk protein isolate), all obtained from Fonterra (New Zealand). Pro-Fam 873 is isolated soy protein from ADM.
**The carbohydrates were obtained from Cargill.
^{†}CocoanOX 45 and CocoanOX 70 are natural cocoa extracts reported to contain about 45 and 70 percent polyphenols, respectively, from Natraceutical Group.
^{‡}MM-100 is a masking agent based on mono-ammonium glycyrrhizinate from Mafco.

Chocolate tablets were prepared containing the spray dried compositions described in the table above using the procedure as described above in Example 5. Additionally, standard chocolate samples containing only CocoanOX 45 and CocoanOX 70 (i.e., no carriers or spray drying; Controls 1 and 2, respectively) were also prepared. The amounts of spray dried polyphenol compositions and the CocoanOX standards added were adjusted to bring the polyphenol levels to about 850 mg per 100 g chocolate. The sensory results are shown below.

| | | Overall |
|---|---|---|
| | Detailed Sensory Evaluation | Evaluation* |
| 1 | cocoa, fruity, chocolaty, slight astringent aftertaste, similar to sample 3 | Good |
| 2 | strong cocoa, astringent (slight dry mouth), bitter, slight fruity, chocolaty, slightly | Good |
| | sweet | |
| 3 | strong cocoa, chocolaty, fruity, bitter, slight astringent aftertaste, sweeter than | Excellent |
| | sample 11, balanced, slightly earthy | |
| 4 | cocoa, more fruity, mid bitter (less than sample 3), more astringent aftertaste | Poor |
| 5 | sweeter than sample 3, slightly less cocoa, chocolaty, slightly astringent, slightly | Good |
| | bitter, milder than 3 but close, balanced | |
| 6 | strong cocoa, fruity, chocolaty, mid bitter, more astringent than samples 3, 11, and | Good |
| | 17 | |
| 7 | cocoa, less fruity, slightly chocolaty, mid bitter, mid astringent (similar to sample 4) | Poor |
| 8 | astringent aftertaste, more bitter, less cocoa, less fruity, flat in chocolaty | Poor |
| 9 | less cocoa, mid bitter, very fruity, mid astringent (similar to samples 4 and 7), less | Poor |
| | balanced than sample 3 | |
| 10 | astringent aftertaste, bitter, cocoa | Poor |
| 11 | mid cocoa, chocolaty, slightly bitter, fruity, slightly astringent aftertaste, more sweet | Excellent |
| 12 | cocoa, more chocolaty, less fruity, slightly sour and bitter aftertaste, more | Good |
| | astringent than samples 3, 11, and 17 (dry mouth) | |
| 13 | mild cocoa, slightly astringent, slightly sour, chocolaty, slightly fruity | Good |
| 14 | mid cocoa, fruity, bitter, slightly less astringent, chocolaty, balanced | Good |
| 15 | mildest sample, chocolaty, flat cocoa, creamy, less bitter, least astringent | Good |
| | aftertaste | |
| Control 1 | less cocoa, very astringent, very bitter, earthy, less sweet, not fruity | Poor |
| Control 2 | less cocoa, very astringent, very bitter, earthy, less sweet, not fruity | Poor |

*Samples labeled good or excellent were considered acceptable.

Based on the sensory evaluation, compositions containing CocoanOX 45 were rated better when compared similar compositions containing CocoanOX 70 even though the amounts were adjusted so that all compositions contained similar overall levels of polyphenols. Of the proteins tested, sodium caseinate, milk protein isolate, and soy protein isolate were preferred. Of the carbohydrates tested, maltodextrin, trehalose, and corn syrups solids (25DE; data not shown) were preferred with maltodextrin being most preferred; although the data is not presented here, high-maltose corn syrup, modified starch, and fibers (e.g., oligofructose (<10DE) and inulin) were tested but did not perform satisfactorily. Carrier systems containing masking agents (e.g., MM-100 or cocoa bufter) were generally rated inferior to similar systems without the masking agents. The system using calcium caseinate (sample 15) was among the mildest and had a very low astringency; but it was also very flat in cocoa and chocolate notes.

Of course, as those skilled in the art will realize, systems which are effective in reducing astringency but which reduce or otherwise negatively effect the desired chocolate flavor attributes might be used, and might even be preferred, in other food products with different flavor profiles. It is the overall evaluation that is important since the encapsulated polyphenols must have, in addition to reduced astringency, no significant negative effects on the organoleptic properties of the food product in which it is being used.

### EXAMPLE 8

This Example illustrates the incorporation of spray dried encapsulated polyphenols into chocolate at various stages of a commercial chocolate production line. Except for the timing of the addition of encapsulated polyphenols into the chocolate and the chocolate production line, the procedures of Example 5 were essentially used.

A first spray dried polyphenol composition was prepared comprising 47.5 percent trehalose, 22.5 percent sodium caseinate, and 30 percent CocoanOX 70. The first spray dried polyphenol composition had a d90 of about 82 microns; the amount added to the chocolate was adjusted to yield a final product containing about 500 mg polyphenols/60 g chocolate. The first spray dried polyphenol composition was then added to separate runs of a pilot plant production process at the following points:

Sample 1—spray dried composition added with dry ingredients that are subsequently refined to produce flakes;

Sample 2—spray dried composition added at the beginning of conching process (along with ingredients normally added at this point, e.g., cocoa liquor); and

Sample 3—spray dried composition added at the end of conching process (along with ingredients normally added at this point, e.g., lecithin, aroma, cocoa butter).

A control sample was also prepared by mixing corresponding amounts of the trehalose and sodium caseinate (without any polyphenols and no spray drying) into a finished chocolate sample from a standard production run.

After three weeks to allow for fat or cocoa butter crystallization, the chocolate samples were evaluated and the following results were obtained:

| Sample | Evaluation |
|---|---|
| Control | very cocoa, fruity, sour, astringent, bitter |
| Sample 1 | cocoa, most bitter, slight astringent in aftertaste, |
| | non-gritty, less sour |
| Sample 2 | gritty, cocoa, fruity, bitter, slight astringent |
| Sample 3 | gritty, cocoa, fruity, bitter, slight astringent, |
| | most similar to Control |

Although Sample 3 was the best polyphenol-containing sample, it was very gritty. Sample 2 was similar to Sample 3. Sample 1 had a good texture was more astringent as compared to Sample 3.

A second spray dried polyphenol composition was prepared comprising 32.5 percent maltodextrin, 22.5 percent sodium caseinate, and 45 percent CocoanOX 45. The second spray dried polyphenol composition was then added to separate runs of a commercial chocolate production line at the following points:

Sample 1—spray dried composition added with dry ingredients that are subsequently refined to produce flakes;

Sample 2—spray dried composition added at the end of conching process (along with ingredients normally added at this point, e.g., lecithin, aroma, cocoa butter); the chocolate containing the encapsulated polyphenols was then subjected to grinding in a ball mill to reduce particle size. The finished encapsulated polyphenol-containing chocolate had a d90 of about 20 microns.

Sample 3—a composition including the spray dried composition and a coarse milled cocoa liquor were ground in a ball mill to provide a fine cocoa liquor containing enough encapsulated polyphenols to deliver essentially the same amount of polyphenols as Samples 1 and 2 in the finished product. The encapsulated polyphenol-containing fine cocoa liquor had a d90 of about 26 microns and was added at the beginning of conching process. The finished product had a similar d90.

After three weeks storage at about 16° C. to allow for fat or cocoa butter crystallization, the chocolate samples were evaluated and the following results were obtained:

| Sample | Evaluation |
|---|---|
| Sample 1 | strong cocoa, gritty, chocolaty, less fruit than |
| | Sample 2, more astringent in aftertaste, bitter |
| Sample 2 | strong cocoa, fruity, creamy, astringent, slightly |
| | bitter, slightly gritty (smooth but with a few |
| | particles), well balanced |
| Sample 3 | strong cocoa, mid fruity, slightly gritty, |
| | chocolaty, most bitter, astringent |

Sample 2 was the best spray dried polyphenol-containing sample of this series; it was perceived as the best in texture and taste, with a stronger fruity note and slightly lower astringency than the other samples, and the best balanced in overall taste. Thus, preferably the encapsulated polyphenols are added at the end of the conching process and the resulting mixture is then subjected to a further milling step before completing the production run to provide the finished chocolate product.

What is claimed is:

1. A method for significantly reducing astringency and bitterness levels in polyphenol compositions when incorporated into a food product and consumed by humans or animals, said method comprising:
(1) providing a polyphenol composition comprising polyphenol particles; and
(2) encapsulating the polyphenol particles with an encapsulating material to form microencapsulated polyphenol particles having encapsulating material surrounding the polyphenol particles;
wherein the encapsulating material is effective for protecting polyphenols in the polyphenol composition from release during normal mastication processes in the humans or animals but which allows release of the polyphenols from the polyphenol compositions during normal digestive processes in the humans or animals, wherein the polyphenols released during normal digestive processes are in a bioactive form, and wherein the microencapsulated polyphenol particles, when incorporated into the food product, have significantly reduced astringency and bitterness levels and do not significantly affect the food product's organoleptic properties.

2. The method of claim 1, wherein the polyphenol compositions contains naturally-occurring polyphenols derived from plants or plant materials, wherein the encapsulating material is a lipid, a gelatin, or a mixture containing a protein and a carbohydrate

3. The method of claim 2, wherein the layer of the encapsulating material is about 10 to about 40 microns thick.

4. The method of claim 2, wherein the microencapsulated polyphenol particles are further treated to remove essentially all particles having a particle size greater than about 1200 microns.

5. The method of claim 3, wherein the microencapsulated polyphenol particles are further treated to remove essentially all particles having a particle size greater than about 1200 microns.

6. The method of claim 3, wherein the encapsulating material is the lipid and wherein the lipid is selected from the group consisting of hydrogenated palm oil, hydrogenated cottonseed oil, hydrogenated soybean oil, hydrogenated coconut oil, cocoa butter, acetylated monoglyceride, and mixtures thereof.

7. The method of claim 5, wherein the encapsulating material is the lipid and wherein the lipid is selected from the group consisting of hydrogenated palm oil, hydrogenated cottonseed oil, hydrogenated soybean oil, hydrogenated coconut oil, cocoa butter, acetylated monoglyceride, and mixtures thereof.

8. The method of claim 3, wherein the encapsulating material is the gelatin.

9. The method of claim 5, wherein the encapsulating material is the gelatin.

10. The method of claim 2, wherein the encapsulating material is the mixture of the protein and the carbohydrate, wherein the protein is a milk protein or a soy protein and the carbohydrate is maltodextrin, trehalose, or corn syrup solids.

11. The method of claim 10, where the protein is milk protein isolate or sodium caseinate and the carbohydrate is maltodextrin or trehalose.

12. A composition comprising polyphenols, wherein the polyphenols are in the form of polyphenol particles encapsulated with an encapsulating material, wherein the encapsulating material is effective for protecting the polyphenols from release during normal mastication processes in a human or animal but which allows release of the polyphenols during normal digestive processes in the human or animal and wherein the polyphenols released during normal digestive processes are in a bioactive form, wherein, when the encapsulated polyphenols are incorporated into a food product, astringency and bitterness levels due to the polyphenols are significantly reduced during consumption of the food product by the human or animal without adversely affecting the food product's organoleptic properties.

13. The composition of claim 12, wherein the polyphenols are naturally-occurring polyphenols derived from plants or plant materials, wherein the encapsulating material is a lipid, a gelatin, or a mixture of a protein and a carbohydrate.

14. The composition of claim 13, wherein the encapsulating material is about 10 to about 40 microns thick.

15. The composition of claim 12, wherein the encapsulated polyphenol particles have been treated to remove essentially all particles having a particle size greater than about 1200 microns.

16. The composition of claim 14, wherein the encapsulated polyphenol particles have been treated to remove essentially all particles having a particle size greater than about 1200 microns.

17. The composition of claim 12, wherein the encapsulating material is the lipid and wherein the lipid is selected from the group consisting of hydrogenated palm oil, hydrogenated cottonseed oil, hydrogenated soybean oil, hydrogenated coconut oil, cocoa butter, acetylated monoglyceride, and mixtures thereof.

18. The composition of claim 14, wherein the encapsulating material is the lipid and wherein the lipid is selected from the group consisting of hydrogenated palm oil, hydrogenated cottonseed oil, hydrogenated soybean oil, hydrogenated coconut oil, cocoa butter, acetylated monoglyceride, and mixtures thereof.

19. The composition of claim 12, wherein the encapsulating material is the gelatin.

20. The composition of claim 14, wherein the encapsulating material is the gelatin.

21. The composition of claim 12, wherein the encapsulating material is the mixture of the protein and the carbohydrate, wherein the protein is a milk protein or a soy protein and the carbohydrate is maltodextrin, trehalose, or corn syrup solids.

22. The composition of claim 21, where the protein is milk protein isolate or sodium caseinate and the carbohydrate is maltodextrin or trehalose.
